(19) United States
(12) Patent Application Publication
(10) Pub. No.: US 2018/0031041 A1
(43) Pub. Date: Feb. 1, 2018

(54) LOW CREEP BEARING AND METHOD FOR INSTALLING IN SUPERCHARGER

(71) Applicant: Eaton Corporation, Cleveland, OH (US)

(72) Inventor: JASON A BRADY, COMMERCE TOWNSHIP, MI (US)

(73) Assignee: Eaton Corporation, Cleveland, OH (US)

(21) Appl. No.: 15/547,420

(22) PCT Filed: Jan. 27, 2016
(86) PCT No.: PCT/US2016/015086

§ 371 Date: Jul. 28, 2017

Related U.S. Application Data
(60) Provisional application No. 62/174,247, filed on Jun. 11, 2015.
(60) Provisional application No. 62/108,836, filed on Jan. 28, 2015.

(51) Int. Cl. F16C 33/66; F01C 21/02; F16C 27/04; F04C 18/12; F04C 29/02; F16C 19/06; F02B 33/38; F02B 39/14

(52) U.S. Cl. CPC F16C 33/6633; F02B 33/38; F01C 21/02; F02B 39/14; F04C 18/123; F04C 29/021; F16C 19/06; F16C 27/045; F04C 2240/50; F16C 2210/04; F16C 2226/12; F16C 2360/43

(57) ABSTRACT

A supercharger assembly comprises a housing, a shaft bore in the housing, a shaft extending into the shaft bore, wherein the shaft comprises an axis, and a bearing assembly located between the shaft bore and the shaft. The bearing assembly comprises an outer ring. The outer ring comprises an outer face. A grease is located between the outer face of the outer ring and the shaft bore. The grease has a viscosity greater than International Standards Organization Viscosity Grade 100.

### FIELD

This application relates to damping techniques in a supercharger and provides a bearing installation for damping rotor shaft motion in a supercharger.

### BACKGROUND

Roots style, or twin rotor, superchargers are subject to chatter as rotating lobes mesh. The chatter causes the rotor shaft to shift in the supercharger housing. Prior art bearings creep in the housing due to chatter and shifting.

Tolerance stack-up can contribute to this chatter, causing vibrations during operation because space exists between parts, for example, in a bearing, between the bearing and the shaft, and between the bearing and the housing of the supercharger. These spaces can expand and contract due to thermal expansion caused by both changes in operating temperature and changes in ambient temperature.

Vibrations can also cause the rotors in a Roots style supercharger to “walk,” that is, move in an axial direction. Walking is undesirable as it can decrease the performance of the supercharger and damage coatings, surfaces, and other parts.

Shear forces created by tolerance stack-up and normal operating conditions can cause parts to deform over time, often referred to as creep.

Conventional superchargers use low viscosity lubricants to lubricate parts, including bearing parts. These low viscosity lubricants are often applied using a pressurized lubricant feed. These low viscosity lubricants can fill some of the spaces, but they do not provide effective damping capability or resistance to shear forces.

### SUMMARY

The disclosure overcomes the above disadvantages and improves the art by way of using a high viscosity damping grease in a supercharger. The supercharger can be of the Roots style, parallel lobe or twin screw lobe, among other styles.

A supercharger assembly comprises a housing, a shaft bore in the housing, a shaft extending into the shaft bore, wherein the shaft comprises an axis, and a bearing assembly located between the shaft bore and the shaft. The bearing assembly comprises an outer ring. The outer ring comprises an outer face. A grease is located between the outer face of the outer ring and the shaft bore. The grease has a viscosity greater than International Standards Organization Viscosity Grade 100.

A method of assembling a supercharger comprises the steps of installing a shaft into a shaft bore and press-fitting a bearing onto a shaft, wherein the bearing comprises an outer ring. The outer ring comprises an outer face. The method further comprises injecting a layer of grease between the outer face of the outer ring and the shaft bore, wherein the grease has a viscosity greater than International Standards Organization Viscosity Grade 100.

A supercharger assembly comprises a housing, a shaft bore in the housing and a shaft extending into the shaft bore. The shaft comprises an axis. The supercharger assembly comprises a bearing assembly located between the shaft bore and the shaft. The bearing assembly comprises an outer ring. The outer ring comprises an outer face. The bearing assembly further comprises a grease located between the outer face of the outer ring and the shaft bore. The grease has a base oil viscosity greater than 1,000 centistokes at 25 degrees centigrade.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIG. 1 is a cross-section view of a supercharger.

FIG. 2A is a cross-section view of a bearing installation.

FIG. 2B is another cross-section view of a bearing installation.

FIG. 3 is another cross-section view of the supercharger.

FIG. 4A is another cross-section view of the supercharger.

FIG. 4B is an enlarged view of area X of FIG. 4A.

### DETAILED DESCRIPTION

Reference will now be made in detail to the examples which are illustrated in the accompanying drawings. Wherever possible, the same reference numbers will be used throughout the drawings to refer to the same or like parts. Directional references such as “left” and “right” are for ease of reference to the figures.

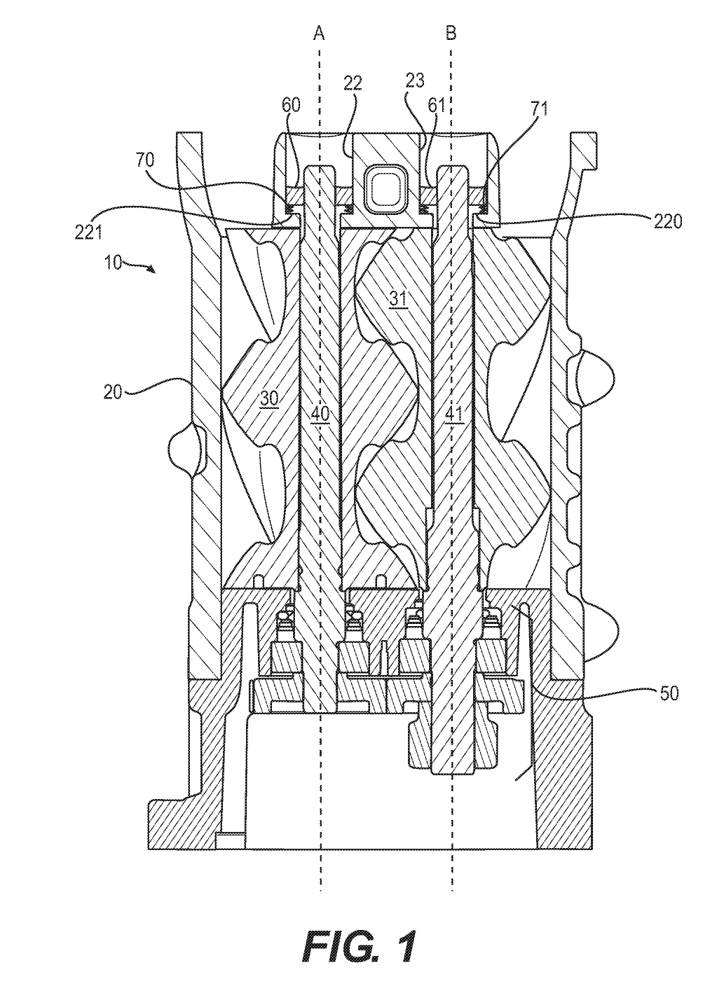

FIG. 1 shows an example of a supercharger assembly 10 comprising rotors 30, 31 in housing 20. Shafts 40, 41 are positioned in the center of rotors 30, 31 along axes A, B. Shafts 40, 41 fit into shaft bores 22, 23 at one end of axes A, B and into transfer case 50 at the other end of axes A, B.

Shafts 40, 41 fit into bearings 60, 61, all of which are located in shaft bores 22, 23. One can fit shafts 40, 41 into bearings 60, 61 before or after placing shafts 40, 41 into shaft bores 22, 23. For example, one can first press-fit first bearing 60 onto first shaft 40, then slip-fit first shaft 40 with first bearing 60 into first shaft bore 22. Or one can first slip-fit first bearing 60 into first shaft bore 22, then press-fit first shaft 40 into first bearing 60, which is already positioned in first shaft bore 22.

Shaft bores 22, 23 can also include compression springs 70, 71, which can serve to apply a spring force to bearings 60, 61 along axes A, B. Compression springs 70, 71 can rest against a steps 220, 221 on one end of compression springs 70, 71 and against bearings 60, 61 on the other end, creating pressure against bearings 60, 61. Compression springs 70, 71 can be preloaded. This arrangement can reduce the axial movement of rotors 30, 31 during operation of the supercharger assembly. Compression springs 70, 71 can also damp axial vibrations, reducing the overall chatter of the supercharger assembly. Because chatter is reduced, bearings 60, 61 can be smaller than prior art bearings.

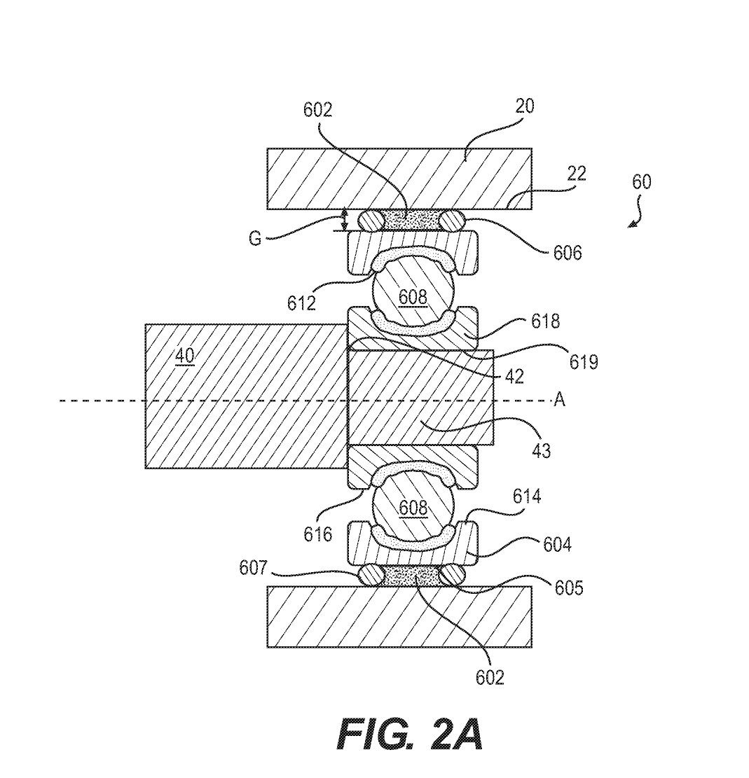

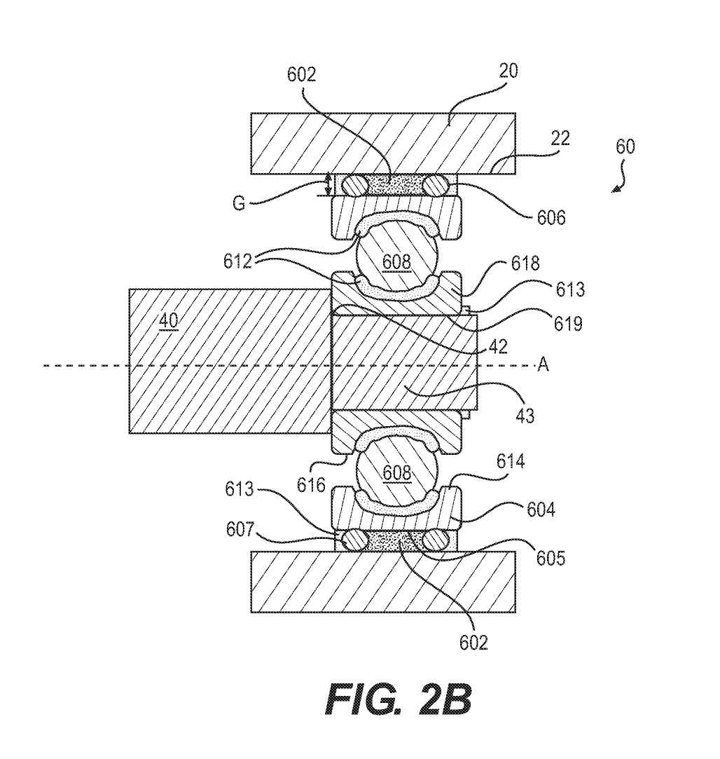

FIG. 2A shows a cross-section of bearing assembly 60 as it fits in housing 20. First shaft 40 can have a step 42 that abuts inner ring 618. One can press-fit the end 43 of first shaft 40 into bearing 60 so that inner ring 618 and end 43 contact each other at the outer face 619 of inner ring 618, fastened together by friction created by the interference where the outer face 619 of inner ring 618 contacts end 43.

Superchargers often include a gap G between the housing 20 and bearing 60. This gap G might not have any material separating bearing 60 from housing 20, thereby creating an open space. The open space increases the vibration of bearing 60. While vibrating, bearing 60 repeatedly contacts housing 20, creating unwanted noise during operation of the supercharger.

In some superchargers, gap G is filled with a bore lubricant 613 often used to lubricate parts of the supercharger. This lubricant can be the same lubricant as bearing lubricant 612 found in bearing 60. The lubricant, however, does not have the damping capability of grease 602.

The gap G can increase during the operation of the supercharger when housing 20 is made of a different material than bearing 60. Housing 20 is often made from aluminum while bearing 60 is often made from steel. Aluminum has a higher rate of thermal expansion than steel. A supercharger can heat up due to many factors, including an increase in the engine operating temperature or an increase in the ambient temperature. If heated, the aluminum housing will expand more than the steel bearing. Thus any gap between the housing and the bearing will increase.

A bearing assembly can be fit into a supercharger housing at a shaft bore such that there is an interference fit between the shaft bore and the bearing. With such a fit the gap G would equal zero. This gap, however, can increase with the change in temperature, thus, losing the interference fit and creating open space where vibration occurs.

To reduce the maximum gap G experienced during thermal expansion, one can create more interference in the interference fit by increasing the diameter of outer ring 604 of the bearing, reducing the diameter of shaft bore 22, or both increasing diameter of the outer ring of the bearing and decreasing the diameter of the shaft bore. This approach, however, can decrease the performance of the supercharger assembly. The interference fit can create unwanted loads on roller elements (e.g., roller elements 608) and on shafts (e.g., shaft 40). These loads can deform the rollers, internal bearing components, and shafts.

Filling gap G with grease 602 alone or in combination with o-rings 606, 607 can reduce these negative affects. For example, grease 602 can damp vibrations and noise not otherwise damped. Using grease 602 to damp vibrations can reduce the radial and axial movement of shafts 40, 41, thus, reducing walking between the supercharger housing 20 and bearing 60.

It can also prevent outer ring 604 from contacting shaft bore 22 during operation. One can also use grease 602 to provide better shear resistance at the interface between shaft bore 22 and outer face 605 of outer ring 604.

Grease 602 can also have a high resistance to creep. Creep, or deformation over time, can occur on parts, especially metal parts such as steel or aluminum, when those parts are exposed to loads over a long period of time. This deformation can increase the noise and vibration during operation and even cause the supercharger assembly to fail.

Having a viscosity greater than International Standards Organization Viscosity Grade (ISO VG) 100 allows a grease 602 to have exceptional damping capability. Greases such as damping grease by Nye Lubricants, Inc. can perform well. High-viscosity damping greases ranging from 1,000 centistokes (cSt) at 25 degrees centigrade to 50,000 cSt or more at 25 degrees centigrade provide excellent damping capability. Some high-viscosity damping greases can withstand temperatures ranging from −40 degrees centigrade to 120 degrees centigrade without immiscibly separating.

Having grease 602 located between bearing 60 and shaft bore 22 can reduce the tolerance between bearing 60 and shaft bore 22. Allowing for more expansion of bearing 60 and housing 20 during operation, grease 602 can reduce other tolerances required, for example, the tolerance distance between shaft end 42 and inner ring 618 of bearing 60. Thus, grease 602 can reduce the overall stack up of tolerances in a supercharger assembly.

Grease 602 does not need a pressurized feed or sump mechanism to maintain its location in the shaft bore. The viscosity of the grease 602 is such that it is placed in the shaft bore and plugged in place. It does not require continual replacement like prior art squeeze-film dampers. It is also more effective at eliminating squeal and other NVH conditions.

The bearing assembly need not have o-rings. Grease 602 can be an unbounded layer between bearing assembly 60 and outer ring 604. O-rings 606, 607, however, can prevent grease 602 from traveling beyond the space in between first o-ring 606 and second o-ring 607. This allows grease 602 to dampen vibrations and help protect the bearing 60 at areas most likely to contact housing 22.

O-rings 606, 607 can also damp vibrations. The material and size of o-rings 606, 607 can be selected so that o-rings 606, 607 damp vibrations and noise of a different frequency than those damped by grease 602. This gives the supercharger assembly the ability to dampen a wider range of frequencies.

It's advantageous to use o-rings 606, 607 that have high resistance to creep so that o-rings 606, 607 prevent grease from leaking beyond o-rings 606, 607 during the useful lifespan of grease 602.

O-rings 606, 607 can also form an interference fit with shaft bore 22 and outer ring 604. This fit not only helps seal grease 602, but it also helps keep bearing 60 from moving axially along axes A.

O-rings 606, 607 can include a radial spring that provides further damping capability. The radial spring can also center bearing 60 and also provide compression force to keep o-rings 606, 607 from moving in the axial direction along axes A.

O-rings 606, 607 might fit into circumferential groves (not shown) along outer ring 604. In a similar way, shaft bore 22 might have circumferential groves (not shown) to accommodate o-rings 606, 607 to provide better sealing capability.

When sizing o-rings 606, 607, one can consider the maximum and minimum distance of gap G experienced during the operation of the supercharger. For example, gap G might be significantly larger when housing 20 heats up, whether due to engine operation or changes in ambient temperature. One can also consider the desired amount of grease 602 when determining the distance of gap G.

Bearing lubricant 612 has a lower viscosity than grease 602. It can be more advantageous for bearing lubricant 612 to provide lubrication rather than damp vibrations.

As shown in FIG. 2B, bore lubricant 613 can serve to lubricate the bearing assembly as the bearing assembly is installed in the shaft bore, or as the bearing assembly is installed on the shaft. The bore lubricant 613 can have a viscosity similar to bearing lubricant 612. Or, bore lubricant can differ from bearing viscosity by being higher or lower in relative viscosity.

Bearing lubricant 612 surrounds roller elements 608, which are illustrated as ball bearings. The viscosity of bearing lubricant 612 can be governed by bearing speed, load, and temperature. One can select bearing lubricant 612 to facilitate high rotation rates of rolling elements 608, but such a lubricant would likely have a very low shear resistance.

Bearing lubricant can be located around raceways (e.g., inner raceway 616 and outer raceway 614) and roller elements. In addition to ball bearings, one can use needle bearings, roller bearings, or taper bearings. The bearing assembly structure can be race-less with no inner race or it can be cage type having rollers retained in and dropped through a cage to contact the rotor shaft.

The bearing 60 can be slip-fit or press-fit to shaft 40 and first shaft bore 22. Lubricant can facilitate the process. Lubricant can facilitate installation of the bearing on the shaft as by being placed on the shaft or as by being placed on outer face 619 of inner ring 618. Lubricant could additionally or alternatively be placed on the outer face 605 of outer race, or on the shaft bore.

A different lubricant than the lubricant used around roller elements 608 can be used to facilitate bearing assembly installation. For example, bearing lubricant 612 used around roller elements 608 can be different than the bore lubricant applied to outer face 619 of inner ring 618 and to outer face 605 of outer ring 604.

However, because grease 602 can be much more viscous than conventional greases and lubricants (e.g., bearing lubricant 612, bore lubricant 613 and other lubricants used to facilitate installation), one can use an unconventional assembly method. Instead of lubricating the exterior of the bearing 60 before slip-fitting or press-fitting the bearing into first shaft bore 22, one can omit the exterior bore lubricant 613 altogether. The bearing 60 can sized with a slightly smaller outer diameter and can be inserted into first shaft bore 22 with o-rings 606, 607. One can then inject grease 602 into gap G.

The distance of gap G can be selected to facilitate installing bearing 60. Using grease 602 in gap G allows one to relax manufacturing tolerances and increase the space between parts because grease 602 can damp and resist motion previously addressed by tightly fitting bearing 60 into first shaft bore 22. Inner diameter of shaft bore 22 can be larger, or outer bearing diameter can be smaller.

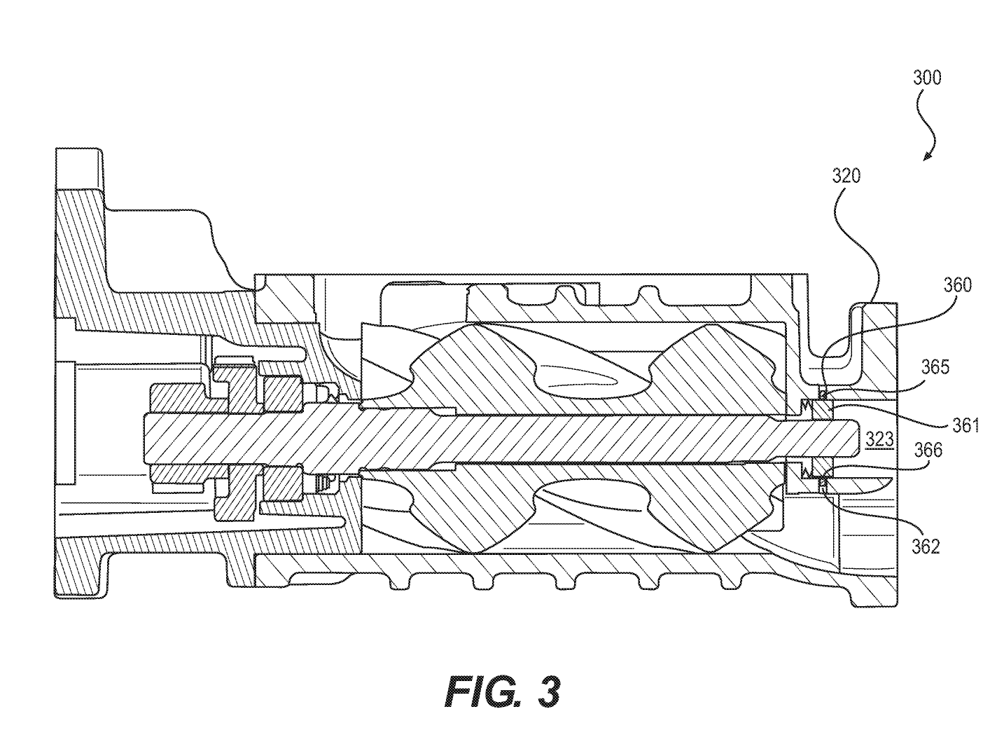

FIG. 3 is a cross-sectional view of a supercharger assembly 300. This arrangement includes a first channel 360 and a second channel 362 allowing fluid communication from outside housing 320 to second shaft bore 323. One can inject grease (e.g., grease 602 of FIG. 1) into shaft bore 323 through channels 360, 362. One can then contain the grease using plugs 365, 366.

One can inject grease into one channel, for example, first channel 360 and monitor second channel 362 for the presence of grease. The presence of grease in second channel 362 indicates that the grease traveled from first channel 360 to second channel 362. After detecting grease in second channel 362, one can plug both first channel 360 and second channel 362 so that grease remains in the shaft bore 323 during operation of the supercharger assembly 300.

The grease can be located between bearing 361 and shaft bore 323 in a manner similar to the arrangement in FIG. 2A, where grease 602 is positioned between first shaft bore 22 and outer ring 604 and retained by o-rings 606, 607.

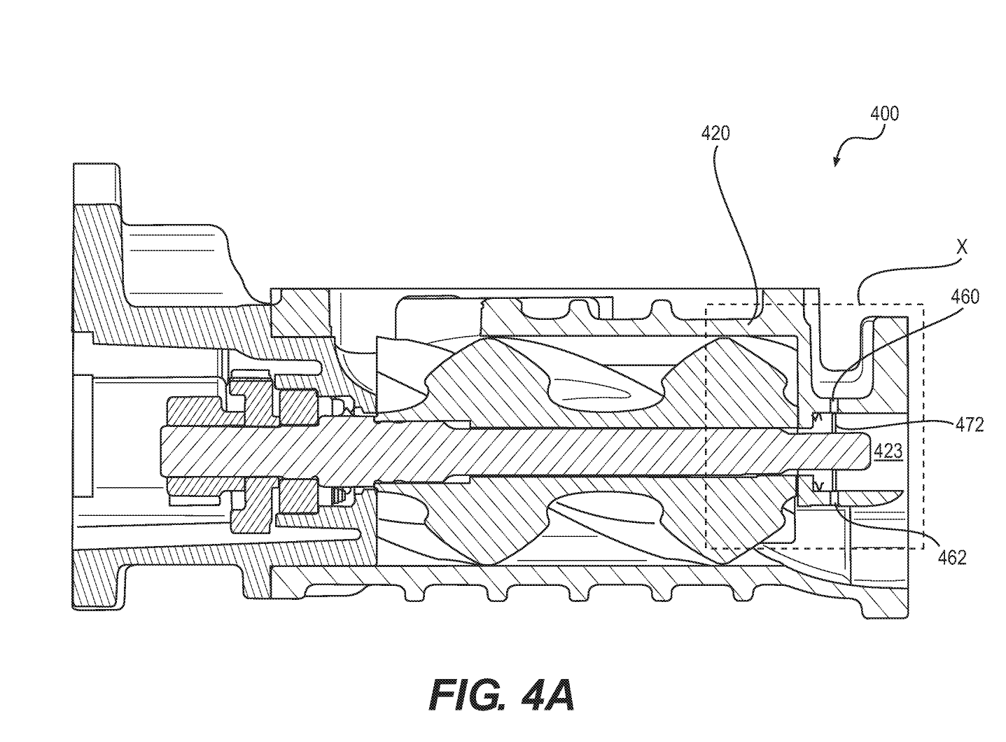

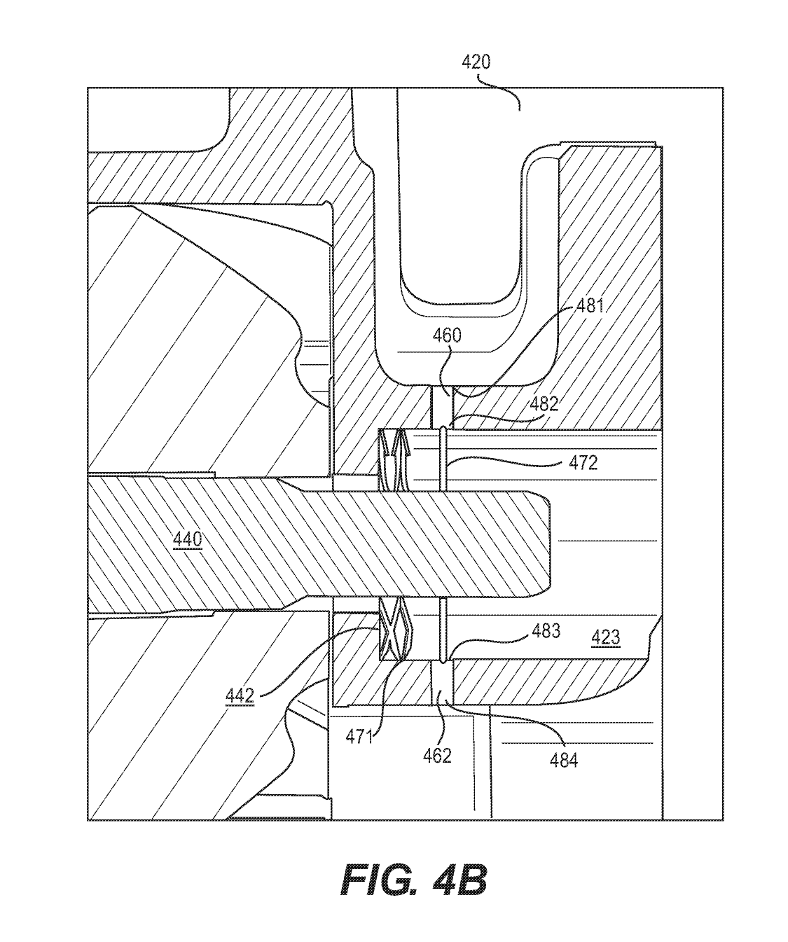

FIG. 4A shows a cross-section view of a supercharger assembly 400.

A circumferential groove 472 can be located in shaft bore 423. Channels 460, 462 can allow one to inject a grease into shaft bore 423. One can inject grease into one channel, for example, first channel 460 in a manner that forces the grease to travel along circumferential groove 472 to second channel 462.

Subsection X identifies the area of supercharger assembly 400 where grease is used to dampen vibrations during operation. This area can include a bearing assembly, for example, any one of the bearing assemblies shown in FIGS. 1-3.

FIG. 4B is a more detailed view of the area identified by subsection X in FIG. 4A. FIG. 4B shows a shaft 440 located in shaft bore 423.

FIG. 4B shows a compression spring 471 abutting step 442 of housing 420. A bearing assembly is not shown, but the compression spring 471 can abut a bearing, thus, exerting an axial force on the bearing assembly.

First channel 460 is in fluid communication with second channel 462 such that a high-viscosity grease can be injected into one channel and travel to the other channel along circumferential groove 472.

The ends of first channel 460 can be defined by first hole 481 and second hole 482. The ends of second channel 462 can be defined by fourth hole 484 and third hole 483. Reference to the ends as first, second, third, or fourth hole is only for convenience to the reader. Any one of these holes can be plugged. Grease can be injected into the holes by many different ways. For example, one can inject grease into first hole 481 or fourth hole 484. Likewise, one can monitor any one or all of these holes for the presence of grease after injecting the grease.

Supercharger assembly 400 need not have both channels 460, 462. Supercharger assembly 400 can be arranged such that a high-viscosity grease (e.g., grease 602 of FIG. 2A) is injected into one channel, for example, first channel 460. After being injected into first channel 460, the high-viscosity grease can travel along circumferential groove 472 until it fills circumferential groove 472. After filling circumferential groove 472 with high-viscosity grease, one can plug first channel 460.

Other implementations will be apparent to those skilled in the art from consideration of the specification and practice of the examples disclosed herein. It is intended that the specification and examples be considered as exemplary only, with the true scope of the invention being indicated by the following claims.

1. A supercharger assembly comprising:
a housing;
a shaft bore in the housing;
a shaft extending into the shaft bore, wherein the shaft comprises an axis; and
a bearing assembly located between the shaft bore and the shaft, the bearing assembly comprising:
an outer ring comprising an outer face;
a grease located between the outer face of the outer ring and the shaft bore, wherein the grease has a viscosity greater than International Standards Organization Viscosity Grade 100.

2. The supercharger assembly of claim 1, further comprising a first o-ring and a second o-ring around the outer ring, wherein the grease is located between the first o-ring and the second o-ring.

3. (canceled)

4. The supercharger assembly of claim 2, further comprising a radial spring, wherein the radial spring abuts either the first o-ring or the second o-ring.

5. The supercharger assembly of claim 2, wherein the grease is the only fluid located between the first o-ring and the second o-ring.

6. The supercharger assembly of claim 2, further comprising a bore lubricant located between the outer face of the outer ring and the shaft bore, wherein the bore lubricant has a viscosity lower than the viscosity of the grease.

7. (canceled)

8. The supercharger assembly of claim 1, further comprising:
rolling elements between the outer ring and the shaft; and
a bearing lubricant lubricating the rollers,
wherein the bearing lubricant comprises a viscosity less than International Standards Organization Viscosity Grade 100.

9. (canceled)

10. The supercharger assembly of claim 8, wherein the rolling elements are one of ball bearings, roller bearings, taper bearings, or needle bearings.

11. (canceled)

12. (canceled)

13. The supercharger assembly of claim 2, wherein the housing comprises a first hole and a second hole, wherein the first hole is in fluid communication with the second hole via a first channel, and wherein the second hole is located in the shaft bore axially positioned between the first o-ring and the second o-ring along the axis.

14. (canceled)

15. The supercharger assembly of claim 1, wherein the housing comprises a third hole and a fourth hole, wherein the third hole is in fluid communication with the fourth hole via a second channel, and wherein the third hole is located in the shaft bore axially positioned between the first o-ring and the second o-ring along the axis.

16. The supercharger assembly of claim 15, wherein the shaft bore comprises a circumferential groove, and wherein the grease can travel from the second hole to the third hole along at least a portion of the circumferential groove.

17. The supercharger assembly of claim 16, wherein the circumferential groove is axially positioned between the first o-ring and the second o-ring.

18. The supercharger assembly of claim 16, wherein the grease is located in the circumferential groove.

19.-29. (canceled)

30. The supercharger assembly of claim 1, wherein the grease has a base oil viscosity of between 1,000 centistokes at 25 degrees centigrade and 50,000 centistokes at 25 degrees centigrade.

30. (canceled)

31. (canceled)

32. The supercharger assembly of claim 6, wherein the grease has a base oil viscosity greater than 1,000 centistokes at 25 degrees centigrade, and wherein the lubricant has a base oil viscosity less than 1,000 centistokes at 25 degrees centigrade.

33. (canceled)

34. The supercharger assembly of claim 8, wherein the grease has a base oil viscosity greater than 1,000 centistokes at 25 degrees centigrade, and wherein the bearing lubricant has a base oil viscosity less than 1,000 centistokes at 25 degrees centigrade.

35. (canceled)

36. A method of assembling a supercharger comprising:
installing a shaft into a shaft bore;
press-fitting a bearing onto the shaft, wherein the bearing comprises an outer ring, and wherein the outer ring comprising an outer face;
injecting a layer of grease against the outer face of the outer ring and in to the shaft bore after installing the shaft in to the shaft bore, wherein the grease has a viscosity greater than International Standards Organization Viscosity Grade 100.

37.-40. (canceled)

41. The method of claim 37, wherein the step of injecting a layer of grease includes injecting the grease into a first channel in the shaft bore and monitoring a second channel in the shaft bore for the presence of the grease.

42.-45. (canceled)

46. The method of claim 45, wherein the step of injecting the layer of grease between the outer face of the outer ring and the shaft bore occurs after the step of installing the shaft into the shaft bore.

47. A supercharger assembly comprising:
a housing;
a shaft bore in the housing;
a shaft extending into the shaft bore, wherein the shaft comprises an axis; and
a bearing assembly located between the shaft bore and the shaft, the bearing assembly comprising:
an outer ring, wherein the outer ring comprises an outer face;
a grease located between the outer face of the outer ring and the shaft bore, wherein the grease has a base oil viscosity greater than 1,000 centistokes at 25 degrees centigrade.

48. The method of claim 47, wherein the grease has a base oil viscosity greater than 1,000 centistokes at 25 degrees centigrade, and wherein the method further comprises applying a lubricant to rolling elements of the bearing, the lubricant having a base oil viscosity less than the grease.
